(19) United States
(12) Patent Application Publication
(10) Pub. No.: US 2014/0102175 A1
(43) Pub. Date: Apr. 17, 2014

(54) Pumped Air Relative Humidity and Temperature Sensing System with Optional Gas Assay Functionality

(71) Applicant: Kent Wasden, Rexburg, ID (US)

(72) Inventor: Kent Wasden, Rexburg, ID (US)

(21) Appl. No.: 13/651,455

(22) Filed: Oct. 14, 2012

(51) Int. Cl. G01N 19/10; G01D 7/04

(52) U.S. Cl. 73/29.02

(57) ABSTRACT

A distributed relative humidity and temperature sensing system with optional gas assay functionality, comprising a sample head internally equipped with: 1) A relative humidity sensor; 2) A temperature sensor; 3) A gas sample port for the attachment of a gas assay device, or, an integral gas assay device; and, 4) A fan. The sample head is attached to a semi-rigid sample tube embedded in a stored mass of agricultural product and the aforementioned fan causes air from within the stored mass to be drawn through the sample head where its relative humidity, temperature, and optionally, chemical composition may be studied. An alternative embodiment allows for the deployment of a complex network of sample tubes so that samples may be drawn as required from a number of points within the stored mass.

### CROSS-REFERENCE TO RELATED APPLICATIONS

Not applicable.

### FIELD OF THE INVENTION

The present invention deals generally with a device and system for measuring relative humidity and temperature remotely from a number of points throughout a large mass of material, such as a pile of potatoes or other agricultural products, having evenly dispersed interstitial air spaces. The present invention also allows for the utilization of gas assay techniques to sample various gases in the air contained in the interstitial spaces at various points within the aforementioned large mass of material.

### BACKGROUND OF THE INVENTION

The ability to store harvested potatoes and similar agricultural products for extended periods of time is an important element in ensuring an adequate food supply because cyclical growing seasons are asynchronous with the steady demand for staple foodstuffs. Globally, conventional and cold storage techniques are well known techniques for the long term storage of onions, potatoes, and the like even in relatively poorly developed nations. See e.g. K. Moazzem & K. Fujita, The Potato Marketing System and Its Changes in Bangladesh: From the Perspective of a Village Study in the Comilla District, 42 The Developing Econ. 63-94 (March 2004). Wherever such products are stored, however, monitoring environmental parameters in the stored mass of product is crucial. Chief among these parameters are relative humidity and temperature. For example, if the relative humidity is kept too low—below 90% —stored potatoes begin to dry out and desiccate. This has a variety of ramifications ranging in importance from loss of product mass and economic value (since potatoes are sold by weight) to total loss of the product. Until now, potatoes, like most agricultural products, are stored according to an articulated set of industry best practices but with no routinely deployed way of monitoring how well those practices work or are being effectuated in a particular application. See e.g.: The Commercial Storage of Fruits, Vegetables, and Florist and Nursery Stocks (K. C. Gross, C. Y. Wang & M. Saltveit eds., U.S. Dept. of Agriculture 2004). In other words, while it is possible to describe what theoretically ideal storage conditions are, it is difficult to know in actual practice whether such conditions have been attained and whether or not they are being maintained inside a mass of stored product. To a large extent, this is because the remote sensing of relative humidity and temperature in such storage environments has heretofore been economically challenging.

Over time, it became apparent that the ability to observe and measure the character and amount of various other gaseous substances besides water that are naturally present in stored agricultural products was also important. For example, normal potato respiration generates not only water but carbon dioxide. Monitoring carbon dioxide levels in potato stores is thought to be particularly crucial. For some time it was suspected that above normal carbon dioxide levels correlated to increased reducing sugar concentration thus causing brown fry color and making them unacceptable to consumers. Giuseppe Mazza and A. J. Siemens, Carbon Dioxide Concentration In Commercial Potato Storage and Its Effect On Quality of Tubers for Processing, 67 American Potato Journal 121-132 (1990). Accordingly, systems measuring relative humidity, temperature, and carbon dioxide levels in potato stores were developed. Eventually, these systems featured many useful innovations, such as unitary relative humidity and carbon dioxide sensors sampling air pumped via sample tubes from a selectable set of sources. These techniques ensured lower deployment costs and ease of calibration. Temperature measurements, on the other hand, were taken via a network of wired thermocouples embedded in the potato bins themselves. As a result, the monitoring system was electrically complex and a large part of it was non-portable and dedicated to the facility in which it was installed. An additional difficulty arose because of the thin nature of the tubes used to collect gas samples. Since such tubes had high surface area to volume ratios, they were thermally unstable and thus encouraged the formation of condensate in the tubes. D. S. Jayas, D. A. Irvine, G. Mazza & S. Jeyamkondan, Evaluation of a Computer-Controlled Ventilation System For A Potato Storage Facility, 43 Canadian Biosystems Engr. 5.5-5.12 (2001).

Eventually however, it became obvious that the role of carbon dioxide in potato storage applications was incompletely understood. More recent research has cast doubts on the earlier view, with one study suggesting that in terms of accelerating the synthesis of reducing sugars in stored potatoes, elevated carbon dioxide levels merely amplify the well-understood effects of ethylene gas. B. Daniels-Lake, R. Prange & J. Walsh, Carbon Dioxide and Ethylene: A Combined Influence on Potato Fry Color, 40(6) HortScience 1824-1828 (2005). Unfortunately, ethylene gas is not only a natural byproduct of stored potatoes and the various pathogens that afflict them, but it is also a commonly used additive to prevent premature sprouting while in storage. As a result, the shifting science and technology involving potato storage dictates that there be a new method of monitoring a wide variety of conditions and compounds inside a mass of stored potatoes. Now, not only relative humidity, temperature, and carbon dioxide levels must be monitored, but in certain circumstances it might be desirable to monitor the levels of oxygen, ethylene, and other chemicals, too.

Moreover, in terms of sensing both relative humidity and temperature and allowing for the utilization of a variety of gas assay instruments, nothing in the prior art is optimized for deployment in agricultural applications, specifically within potato storage facilities. Systems using a multiplicity of wired or wireless relative humidity and temperature sensors are unsuitable because they require a multiplicity of relatively costly sensors incapable of detecting other substances, as discussed above. Also, as discussed above, such systems must be fixed in a particular location and cannot be moved. Further, while gas sampling systems constructed with thin nylon or Tygon® tubes or the like are unsuitable as discussed above because of the possibility of condensate formation, they are also unsuitable because the tubing may become pinched or bent and thus constrict the flow of air. What is needed then, is a low cost, portable means of deploying one relative humidity and temperature sensor in such a manner that samples may be drawn from a one or more of a multiplicity of remote sample points within a pile of potatoes, or other agricultural product, while providing for the simultaneous inclusion or attachment of a gas sensing apparatus to determine the levels various gaseous chemical compounds or elements in the pile.

It is thus a first object of the present invention to provide a unitary device to measure relative humidity and temperature derived from one or more locations in one or more independent masses of stored agricultural product. It is a second object of the present invention that a gas assay apparatus such as a general purpose gas chromatograph or a dedicated purpose gas sensing device may be readily included within or attached to and removed from, the present invention. It is a third object of the present invention that the requisite air sampling tube be of low cost and rigid enough to avoid kinks and closures when deployed in a settling mass of agricultural product yet be large enough in diameter to allow sufficiently high airflow through the sampling tube such that the effect of any localized temperature variation and condensate formation in the air sampling tube is limited.

### SUMMARY OF THE INVENTION

The present invention is comprised of two major parts: 1) A sample head housing the temperature and relative humidity sensing apparatus, the gas test port or dedicated gas assay device, and the air evacuating device; and, 2) A sample collection system comprising a sample collection main line and, optionally, a multiplicity of sample collection lateral lines.

The sample head is generally in the form of a hollow cylinder, closed at one end with a sample collection main line adapter capable of being removably connected to a sample collection main line and closed at the other end with an air evacuating device, such as a “muffin fan” capable of evacuating air from the interior of the sample head and thus drawing air in from the attached sample collection main line. The air evacuating device must be placed “downstream” of the various sensors in the sample head so that the temperature of the motor and energy imparted to the air, and resulting slight heating caused by the fan, does not alter the temperature of the air before it is tested. The sample head is equipped with a relative humidity sensor and a temperature sensor, both of which penetrate from the outside of the sample head into the interior of the sample head such that they measure the relative humidity and temperature, respectively, of the air inside the sample head. The relative humidity and temperature sensors may be of the “direct read” variety, i.e. have an integral digital readout to display the relative humidity and temperature, respectively, of the air presently in the sample head, or both may be of the digitizing variety wherein the digital data is transmitted to, recorded on, and displayed by a dedicated recording and display device or a general purpose computer. Similarly, a gas sample tube penetrates from the outside of the sample head to the inside of the sample head. Ordinarily, this gas sample tube is capped, but by removing the cap, a gas assay apparatus may be attached to the sample tube and through it withdraw air from the interior of the sample head. The gas assay apparatus may be any of the usual variety, ranging from a general purpose gas chromatograph to a single- or multi-purpose detector capable measuring the concentration of one or several compounds or elements, such as: oxygen, carbon dioxide, methane, methanol, ethanol, ethane, ethylene, isopropyl N-(3-chlorophenyl) carbamate, etc. In an alternative embodiment, the gas sample tube may be omitted and a direct read or digitizing gas assay apparatus may be installed into the sample head in its place.

The sample collection system typically is constructed of polyvinyl chloride (PVC) pipe and may be as simple as a single length of PVC pipe or as complex as a multi-branch network with numerous sample collection lateral lines each isolated from the sample collection main line by means of a solenoid valve. PVC is preferred as a material for a variety of reasons. First, it is inexpensive. Second, it is non-reactive with foodstuffs stored in close proximity. Third, it is semi-rigid. Specifically, it is rigid enough not to be deformed when stored material is piled on top of it, but flexible enough such that minor reconfigurations and settling in the stored material will not disrupt the system. The terminal end of the sample collection main line and each sample collection lateral line (if any) are equipped with a gas permeable, dirt impervious filter to prevent debris from being drawn into the sample collection system. Depending on environmental conditions, the sample collection system may be insulated. In the simplest embodiment, a sample collection main line is embedded in each area or bin of stored material. In complex embodiments the sample collection main line is used to collect samples from a multiplicity of sample collection lateral lines, each of which is embedded in a different mass of stored material. In this latter configuration, a solenoid valve isolates the sample collection lateral lines from the sample collection main line and a solenoid valve is installed in the sample collection main line just before the gas permeable, dirt impervious filter at its terminal end. By this means, air may be sampled from any one of the sample collection lateral lines or the sample collection main line. In this embodiment, each sample collection lateral line terminates in a pile of stored agricultural product while the sample collection main line terminates in ambient air in the storage facility. This latter port is used to precondition the sample collection main line to a known condition and thus allow the system to more accurately calculate the temperature in each area or bin. These systems also necessarily comprise a switching means, such as a manual switch panel or a multi-contact digital to analog switch device, capable of supplying activating power to each of the solenoid valves thus allowing the user to select whether one of the sample collection lateral lines or the sample collection main line will be sampled.

The simplest embodiment of the system is used in the following manner: First, some amount of stored material, such as potatoes, is placed in the storage facility. Second, the sample collection main line is placed in the storage area on the top of the stored material. Third, additional stored material is placed on top of the first layer of stored material such the sample collection main line is embedded in the mass of stored material with the free end of the sample collection main line extending to the top of the pile of stored material. Because of the insulative nature of the outer layers of a mass of stored agricultural product, temperatures in the pile are usually higher at the center of the mass. Thus, it is important that the end of the sample collection line terminates at or near the center of the mass. After the storage facility is completely filled, the sample head is attached to the free end of the sample collection main line. If the system comprises a direct read relative humidity sensor and thermometer, the user simply activates the fan in the sample head and after waiting a suitable time to transport a new air sample through the sample collection main line and into the sample head, reads the relative humidity and temperature of the air in the sample head. If the system comprises a relative humidity and temperature sensor that generates an electrical signal coded to indicate measured relative humidity and temperature, respectively, these sensors are electrically connected to a dedicated recording and display device or general purpose computer capable of storing, retrieving, and displaying the measured relative humidity and temperature in a human perceptible form. Similarly, if the system comprises a direct read gas assay device, the user reads the concentration of the one or more gasses sampled. Also, if the system comprises a gas assay device that generates an electrical signal coded to indicate the identity and concentration of one or more compounds or elements, this device is electrically connected to a dedicated recording and display device or general purpose computer capable of storing, retrieving, and displaying the identity and concentration of the one or more substances in a human perceptible form. The user then tests the next pile or bin of stored product in the same manner, and so on.

The more complex, distributed embodiment of the system are used in the following manner: Before use, the sample collection main line with its solenoid valves and all necessary control wiring is permanently affixed in the storage facility with the terminal end of the sample collection main line with its gas permeable, dirt impervious filter extending into the ambient air atmosphere in the storage facility. Next, some amount of stored material, such as potatoes, is placed in one area or bin in the storage facility. Next, a sample collection lateral line with its gas permeable, dirt impervious filter at its terminal end is connected to the sample collection main line and extended into the selected storage area or bin on the top of the stored material. Next, additional stored material is placed on top of the first layer of stored material such the sample collection branch line is largely if not completely embedded in the mass of stored material. As above, because of the insulative nature of the outer layers of a mass of stored agricultural product, temperatures in the pile are usually higher at the center of the mass. Thus, it is important that the end of each sample collection lateral line terminates at or near the center of the mass. In this more complex embodiment, a single large mass of product may require a multiplicity of sample lines to effectively sample conditions inside a large, distributed central zone of product. Alternately, in applications in which product is stored in smaller individual bins the sample collection line ideally terminates in the center of the mass of product stored in the particular area or bin. The preceding two steps are repeated until the entire facility or all of the bins are filled. Next, the sample head is attached to the free end of the sample collection main line. Next, the user then electrically opens the solenoid valve at the terminal end of the sample collection main line and activates the fan to precondition the interior surface of the sample collection main line to a temperature approximating the ambient temperature in the storage facility. Next, the user electrically closes the solenoid valve at the far end of the sample collection main line and actuates the solenoid valve that opens the sample collection branch line that extends into the first storage area or bin to be sampled. After running the fan for a period of time sufficient to transport air from the interior of the storage area or bin to the sample head, the user notes the temperature of the air passing through the sample head. The temperature of the air in the storage area or bin being sampled is calculated from the following measured or known factors: 1) The temperature difference between sampled air when flowing through the sample head and the ambient temperature of air in the storage facility; 2) The length of the sample collection main line from the sample head to the solenoid valve controlling the flow of air from the sample collection branch line being sampled; 3) The diameter of the sample collection main line; 4) The volumetric flow of the stream of air being drawn through the sample collection main line; and, 5) the “R” value of the PVC pipe (and insulation, if any) in the sample collection main line. From these observations, it is possible to closely calculate the temperature of the air being drawn into the sample collection branch line. As above, if the sample head also comprises a direct read gas assay device, the user also reads the concentration of the one or more gasses sampled. After recording the calculated temperature, measured relative humidity, and identity and concentration of other gasses (if measured), the user electrically closes the solenoid valve that opens the sample collection branch line that extends into the storage area or bin just sampled and electrically opens the solenoid valve at the terminal end of the sample collection main line to precondition the interior surface of the sample collection main line to a temperature approximating the ambient temperature in the storage facility. The user then repeats the above steps with the second storage area or bin to be sampled, and so on. If the system comprises relative humidity and temperature sensors that generate an electrical signal coded to indicate measured relative humidity and temperature, respectively, these sensors are electrically connected to a dedicated recording and display device or general purpose computer capable of storing, retrieving, and displaying relative humidity and temperature in a human perceptible form. As above, if the sample head comprises a gas assay device that generates an electrical signal coded to indicate the identity and concentration of one or more compounds or elements, this device is also electrically connected to a dedicated recording and display device or general purpose computer capable of storing, retrieving, and displaying the identity and concentration of the one or more substances in a human perceptible form. Finally, if the system incorporates a multi-contact digital to analog switch device, the general purpose computer used to store, retrieve, and display calculated temperature, measured relative humidity, and identity and concentration of other gasses (if measured) may also: 1) Calculate and store the temperature of the air in the sampled area or bin; and, 2) Automate the process of repetitively collecting samples from the various storage areas or bins.

Optionally, if the sample head does not comprise a gas assay device in lieu of the gas sample port, the user may attach a general purpose gas assay apparatus to the gas sample port, and by this means collect detailed analytical data regarding the nature and composition of the gasses passing through the sample head. If the system incorporates a general purpose computer, the general purpose computer may also store, retrieve, and display data regarding the identity and concentration of other gases as measured by the attached general purpose gas assay device as air from the various storage bins is sampled.

Monitoring gas levels in the mass of stored product is important for a host of reasons. In the case of potatoes, for example, low concentrations of ethylene gas are applied to prevent sprouting and reduce spoilage. As discussed above, it is believed that elevated carbon dioxide in the storage environment synergistically interacts with ethylene gas to raise the amount of reducing sugar in the tuber and thus has the potential to darken the fry color of potatoes stored in such an environment. Id. Remediation techniques (e.g. ventilation) cannot be undertaken on a cost effective “as needed” basis unless an accurate assessment of the concentration of ethylene and carbon dioxide in the stored product is available. This embodiment of the present invention allows this assessment.

### BRIEF DESCRIPTION OF THE DRAWINGS

FIG. 1a is a three-quarter view of the right-hand side of one embodiment of the sample head.

FIG. 1b is a three-quarter view of the right-hand side of a second embodiment of the sample head.

FIG. 2 is a three-quarter view of the right-hand side of a third embodiment of the sample head showing it connected to a data recording and display device such as a computer.

FIG. 3 is a three-quarter view of the right-hand side of a third embodiment of the sample head showing it connected to a general purpose gas assay device such as a portable gas chromatograph and a data recording and display device such as a computer.

FIG. 4 is a schematic diagram illustrating the sample head and sample collection main line in accordance with the first embodiment of the present invention.

FIG. 5 is a schematic diagram illustrating: 1) A general purpose computer used to store, retrieve, and display measured relative humidity and temperature data and also: i) Calculate and store the temperature of the air in the sampled area or bin; and, ii) Automate the process of repetitively collecting samples from the various storage areas or bins; 2) The sample head; and, 3) A complex sample collection system comprising a sample collection main line and a multiplicity of sample collection lateral lines in accordance with the first embodiment of the present invention.

### DETAILED DESCRIPTION OF THE INVENTION

The present invention is comprised of two major parts: 1) A sample head generally comprising various forms of relative humidity and temperature sensing apparatus, a gas test port or dedicated gas assay device, and a fan; and, 2) A sample collection system comprising: i) A sample collection main line; or, ii) A sample collection main line and a multiplicity of interconnected sample collection lateral lines.

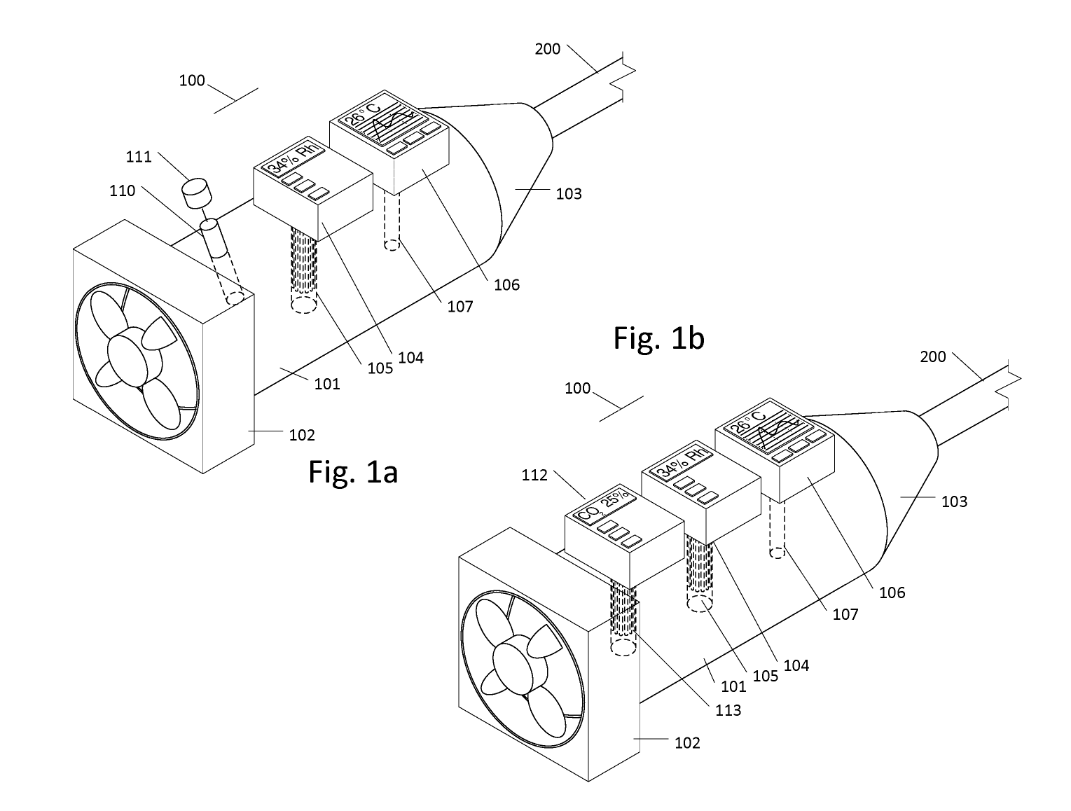

Turning now to FIGS. 1a and 1b, sample head 100 is generally in the form of a hollow cylinder 101 or box, closed at one end with a sample collection main line adapter 103 capable of being removably connected to a sample collection main line 200 and closed at the other end with an air evacuating means 102 such as a “muffin fan,” axial blower, centrifugal air blower, or the like, capable of evacuating air from the interior of the sample head 100 and thus drawing air in from attached sample collection main line 200. Without regard to the particular kind of device used, air evacuating means 102 must be placed “downstream” of the various sensors and gas sample port 110 (if equipped) in sample head 100 so that the temperature of the motor and the energy imparted to the air (and resulting slight heating) caused by the air evacuating device does not alter the temperature of the air before it is tested. Without limitation, sample head 100, sample collection main line adapter 103, and sample collection main line 200 are comprised of polyvinyl chloride (PVC), nylon, or metal and may be insulated.

Referring to FIG. 1a, in a first embodiment of the present invention, sample head 100 may be equipped with a direct read relative humidity sensor 104 and a direct read temperature sensor 106, both of which penetrate from the outside of sample head 100 into the open interior of sample head 100 such that their sensing elements 105 and 107, respectively, are capable of measuring the relative humidity and temperature, respectively, of the air inside sample head 100. Direct read relative humidity and temperature sensors include an integral display capable of showing the current temperature and relative humidity, respectively, or, in some versions, displaying a summary of previously recorded temperatures and/or relative humidity readings. Gas sample tube 110 penetrates from the outside of sample head 100 to the open interior of sample head 100. Ordinarily, gas sample tube 110 is closed by cap 111, but by removing cap 111, the collection tube from a separate gas assay apparatus may be attached to gas sample tube 110 so that the gas assay apparatus may withdraw air from the interior of sample head 100.

Referring to FIG. 1b, in a second embodiment of the present invention, sample head 100 is equipped with a direct read relative humidity sensor 104, a direct read temperature sensor 106, and a direct read carbon dioxide sensor 112, all of which penetrate from the outside of sample head 100 into the open interior of sample head 100 such that their sensing elements 105, 107, and 113 are capable of measuring the relative humidity, temperature, and carbon dioxide concentration respectively, of the air inside sample head 100. As described above, direct read relative humidity, temperature, and carbon dioxide sensors include an integral display capable of showing the current relative humidity, temperature, and carbon dioxide concentration, respectively, or displaying a summary of previously recorded relative humidity, temperature, and/or carbon dioxide concentrations.

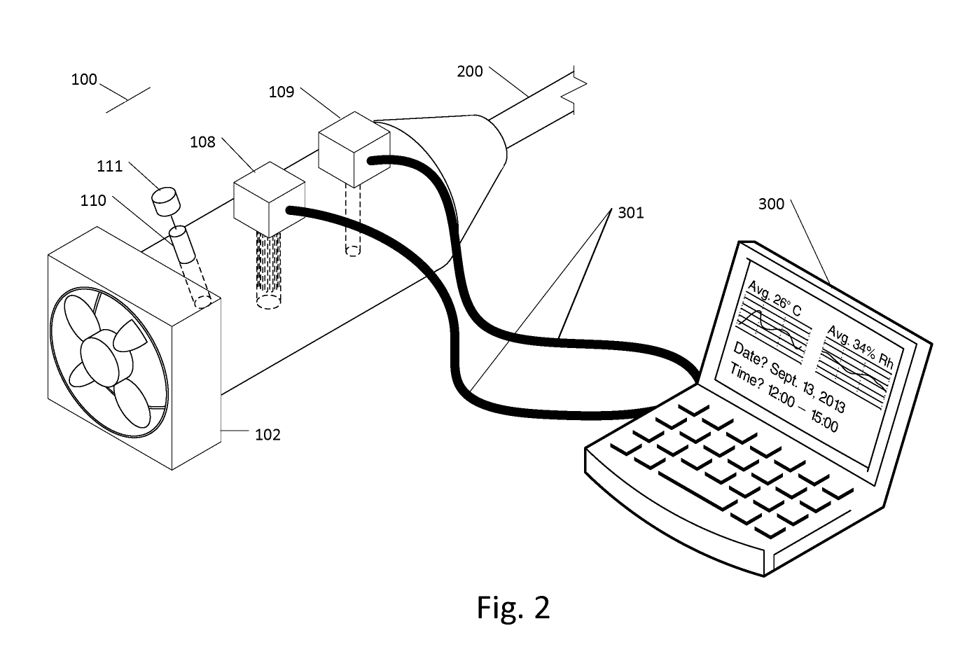

Turning now to FIG. 2, in a third embodiment of the present invention sample head 100 may be equipped with a digitizing relative humidity sensor 108 and a digitizing temperature sensor 109 wherein digital data coded to represent the relative humidity and temperature, respectively, of the air in sample head 100 is transmitted wirelessly or via data cables 301 to a dedicated recording and display device or a computer 300 executing a software program capable of storing, querying, and displaying stored relative humidity and temperature data. Relative humidity and temperature sensors integrated into one direct read or digital sensor device are, of course, well known in the art and may be substituted for the separate relative humidity and temperature sensors discussed above. As above, a third sensor, for example a digitizing carbon dioxide sensor, may be installed in lieu gas sample tube 110. It should be readily apparent that any number or combination of direct read and/or digitizing sensors may be installed in sample head 100. All such alternative configurations are included in the spirit and scope of the present invention.

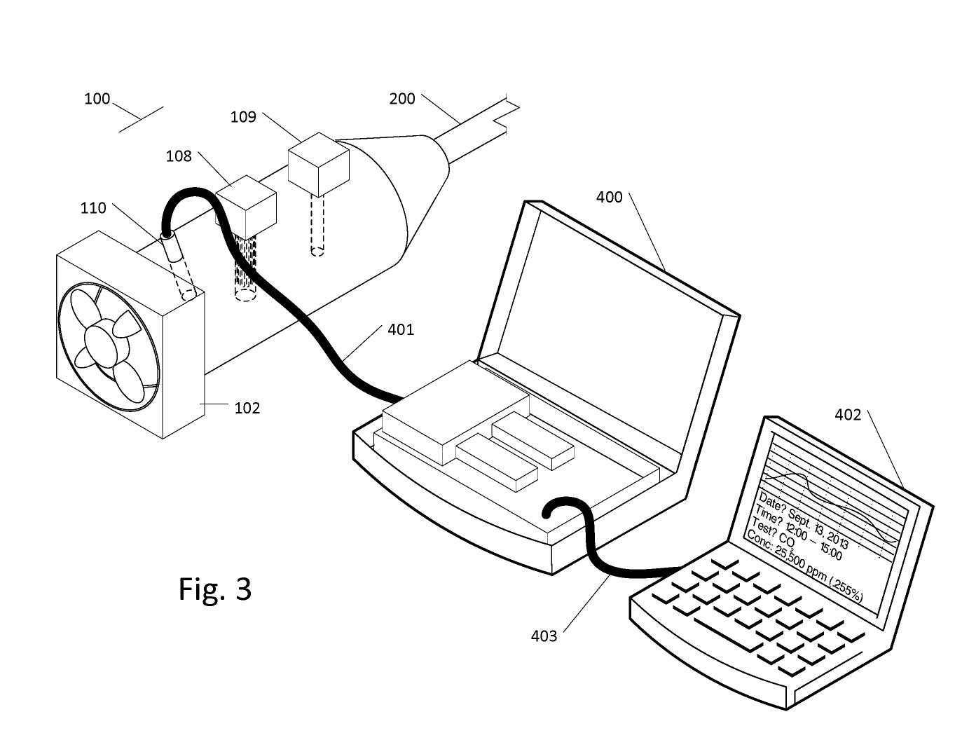

Turning now to FIG. 3, gas assay apparatus 400 may be a general purpose gas chromatograph (as shown) or a handheld single purpose detector capable of measuring the concentration of one, or several, compounds or elements, such as: oxygen, carbon dioxide, methane, methanol, ethanol, ethane, ethylene, etc. Many gas assay devices are equipped with an electrical interface wherein digital data coded to represent the identity, composition, and concentration of various detected gasses is transmitted wirelessly or via data cable 403 thus allowing the user to connect gas assay apparatus 400 to, for example, general purpose computer 402 or a network. Computer 402 executes a software program capable of storing, querying, and displaying stored data derived from gas assay device 400.

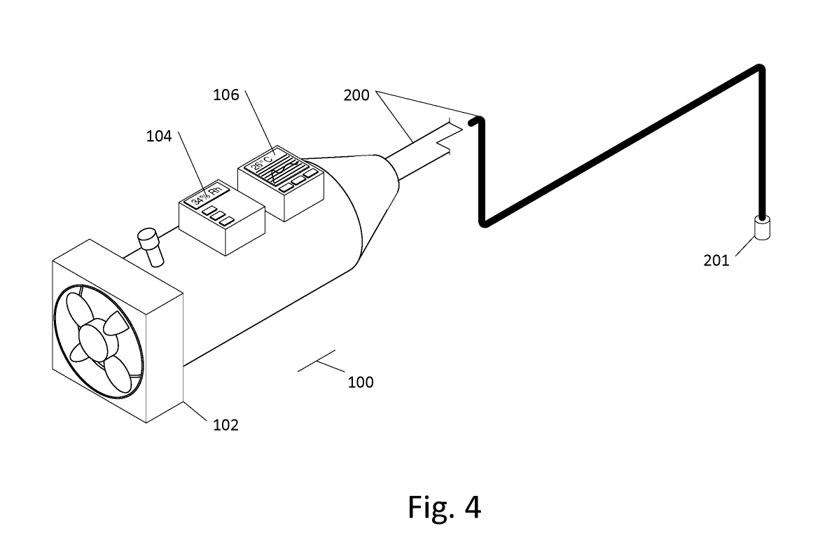

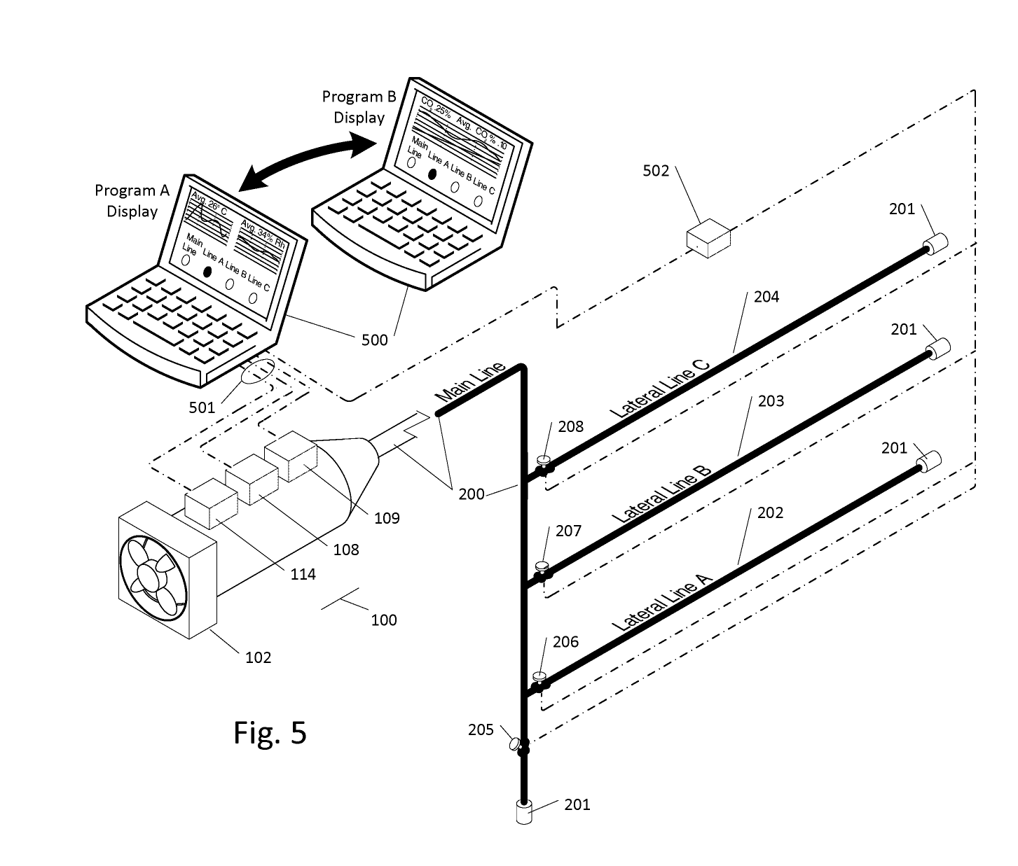

Turning now to FIGS. 4 and 5, the sample collection system is preferably constructed of polyvinyl chloride (PVC) pipe. The sample collection system may be as simple as a single length of PVC pipe serving as the sample collection main line 200 or as complex as a multi-branch network with numerous sample collection lateral lines 202, 203, and 204 each isolated from sample collection main line 200 by means of a manually operated or electrically operated valve, preferably a solenoid valve, 206, 207, and 208, respectively. PVC is preferred as a material of reasons. First, it is inexpensive. Second, it is non-reactive with foodstuffs stored in close proximity to it. Third, it is semi-rigid. Specifically, it is rigid enough not to be deformed when stored material is piled on top of it, but flexible enough such that minor reconfigurations and settling in the stored material will not disrupt the system. While PVC is preferred, other materials are suitable, particularly for constructing the sample collection main line in complex sample collection systems. Such materials include, without limitation, rubber, plastic, or vinyl tube, hose or line or various types of insulated “mini-duct” tubes as often used in high velocity air conditioning systems. Like sample head 100 sample collection main line 200 may be insulated.

Referring now to FIG. 4, in its simplest embodiment the sample collection system is comprised solely of sample collection main line 200, which is, in turn, comprised of PVC pipes and PVC fittings. At the distal end of sample collection main line 200, a gas permeable, dirt impervious filter 201 is installed to prevent debris from being drawn into gas sample collection main line 200.

This embodiment of the present invention is used in the following manner: First, some amount of stored material, such as potatoes, is placed in the storage facility. Second, sample collection main line 200 is placed on the top of the stored material, such that gas permeable, dirt impervious filter 201 will be generally located in the center of the mass of stored product when the storage area or bin is filled. Third, additional stored material is placed on top of the first layer of stored material such the sample collection main line 200 is embedded generally in the center of the mass of stored material with the free end of the sample collection main line 200 extending to and accessible area at the top of the pile of stored material. This placement is crucial, because the outer periphery of a pile of stored agricultural product insulates the innermost regions. Since heat is a byproduct of respiration in potatoes, for example, the temperature at the core of the pile tends to be considerably higher than at the periphery. Thus, it is important that the end of the sample collection line terminates at or near the center or the mass. After the storage facility is completely filled, sample head 100 is attached to the free end of sample collection main line 200. The user next activates air evacuating means 102 in sample head 100. After waiting a suitable time to: 1) Transport sample air extracted from the pile of stored material beyond the terminus of sample collection main line 200 to sample head 100; 2) Fill the interior of sample head 100; and, 3) Allow for the measurement latency time of direct read relative humidity sensor 104 and direct read temperature sensor 106, respectively, if any, the then used reads the relative humidity and temperature of the air in the sample head. Since the air being measured was previously located in the pile of stored material beyond the terminus of sample collection main line 200, and the temperature of the walls of sample collection main line 200 approximate the temperature of the air in the pile of stored material, the relative humidity and temperature of the air in sample head 100 approximates the relative humidity and temperature of the air in the center of the stored pile of material at a point just beyond the terminus of sample collection main line 200.

Referring now to FIG. 5, a more complex embodiment of the present invention is disclosed. Here, the sample collection system is comprised of sample collection main line 200 and a multiplicity of sample collection lateral lines 202, 203, and 204, each of which is, in turn, comprised of PVC pipes and PVC fittings. At the distal end of sample collection main line 200 and sample collection lateral lines 202, 203, and 204, a gas permeable, dirt impervious filter 201 is installed to exclude debris. In this embodiment, sample collection lateral lines 202, 203, and 204 extend from sample collection main line 200 such that the terminal ends of sample collection lateral lines 202, 203, and 204 are placed in different areas of the stored product. Ordinarily, for example, the terminus of each of sample collection lateral lines 202, 203, and 204 would be placed in a different bin of stored product or would be distributed around the center area of single larger mass of stored product. In this embodiment, solenoid valves 206, 207, and 208 isolate sample collection lateral lines 202, 203, and 204, respectively, from sample collection main line 200. Similarly, a manually operated or electrically operated valve, preferably a solenoid valve, 205 is installed in sample collection main line 200 just before gas permeable, dirt impervious filter 201 at its terminus. In this embodiment, while each of sample collection lateral lines 202, 203, and 204 terminates in stored agricultural product, sample collection main line 200 terminates in ambient air in the storage facility. This latter port is used to precondition the interior of sample collection main line 200 to a known thermal state thus allowing the system to more accurately calculate the temperature in each area or bin. In this embodiment, a valve selecting means capable of powering solenoid valves 205, 206, 207, and 208 is needed to select which one of the lines from which the system draws air. Such a valve selecting means may be a simple switch panel or a computer 500 with a suitable multi-contact digital to analog switch device 502 wherein computer 500 signals multi-contact digital to analog switch device 502 causing it to activate one of solenoid valves 205, 206, 207, or 208. In this embodiment, sample head 100 is equipped with digitizing relative humidity sensor 108, a digitizing temperature sensor 109, and digitizing carbon dioxide gas assay device 114 wherein digital data coded to represent the relative humidity, temperature, and concentration of carbon dioxide respectively, of the air in sample head 100 is transmitted via data cables 501 to computer 500. In this embodiment, computer 500 simultaneously executes the following software programs: 1) “Program A” that: i) Collects data derived from digitizing relative humidity sensor 108 and digitizing temperature sensor 109; and, ii) Calculates the temperature of air in the storage area or bin being sampled; and, iii) Stores, queries, and displays relative humidity and temperature data derived from digitizing relative humidity sensor 108 and digitizing temperature sensor 109 as well as the calculated temperature of the air derived from sample collection lateral lines 202, 203, and 204; 2) “Program B” that: i) Collects data derived from digitizing carbon dioxide gas assay device 114; and, ii) Stores, queries, and displays carbon dioxide concentration data derived from digitizing carbon dioxide gas assay device 114 as it samples air from sample collection lateral lines 202, 203, and 204; and, 3) “Program C” that automates the sequential collection of air samples from sample collection lateral lines 202, 203, and 204. By this means, computer 500 can fully automate the process of sequentially selecting a particular sample line thus allowing “Program A” to record the raw relative humidity, temperature, and the calculated temperature of the air sampled from the terminus of each line and “Program B” to record the carbon dioxide concentration of the air sampled from the terminus of each line before moving to the next sample collection lateral line.

This embodiment the present invention is used in the following manner: Before use, sample collection main line 200 with solenoid valves 205, 206, 207, and 208, multi-contact digital to analog switch device 502, and all necessary control wiring extending from multi-contact digital to analog switch device 502 to solenoid valves 205, 206, 207, and 208 is permanently affixed in the storage facility with the terminus of sample collection main line 200 with its gas permeable, dirt impervious filter 201 extending into the ambient air atmosphere in the storage facility. Next, some amount of stored material, such as potatoes, is placed in the storage area or multiplicity of bins in the storage facility. Next, sample collection lateral lines 202, 203, and 204 with their gas permeable, dirt impervious filters 201 at their terminal ends are connected to sample collection main line 200 and extended collectively into the storage area or individually into the multiplicity of bins on the top of the material placed there. Next, additional stored material is placed on top of the first layer of stored material such that sample collection branch lines 202, 203, and 204 are largely if not completely embedded in the stored material. As discussed above, the outer periphery of a pile of stored agricultural product insulates the innermost regions. As a result, the temperature at the core of the pile tends to be considerably higher than at the periphery. Thus, it is important that the end of sample collection lateral lines 202, 203, and 204 terminate at or near the center of the mass to be sampled. In this more complex embodiment, a single large mass of product may have a correspondingly larger central mass and thus require a multiplicity of sample lines to effectively sample conditions. Alternately, in applications in which higher-value product is stored in individual bins each of sample collection lateral lines 202, 203, and 204 ideally terminates in the center of the mass of product stored in a particular bin. Next, sample head 100 is attached to the free end of the sample collection main line 200. Computer 500 is electrically connected to digitizing relative humidity sensor 108, digitizing temperature sensor 109, digitizing carbon dioxide gas assay device 114 and multi-contact digital to analog switch device 502. Next, the user activates air evacuating means 102 in sample head 100 and executes the software programs described above on computer 500. The software programs running on computer 500 perform the following steps:

1) “Program C” opens solenoid valve 205 at the terminal end of the sample collection main line 200 thus allowing ambient temperature air to flow through sample collection main line 200. This step is important because it preconditions the interior surface of sample collection main line 200 to a temperature approximating the ambient temperature in the storage facility. Since all samples from all areas or bins are routed from the individual area or bin to sample head 100 via sample collection main line 200, optimal results are assured when sample collection main line 200 is returned to a known thermal state before collecting a new sample. The restoration of a known thermal state is achieved when the temperature of the air as measured by digitizing temperature sensor 109 in sample head 100 approximates the ambient temperature in the storage facility.
2) “Program C” closes solenoid valve 205 at the far end of the sample collection main line 200 and actuates solenoid valve 206 that opens sample collection lateral line 202 extending into the first storage area or bin to be sampled.
3) After “Program C” has ensured that air evacuating means 102 has operated for a period of time sufficient to transport air from the interior of the selected storage area or bin to sample head 100, “Program A” reads and records the temperature and relative humidity of the air as measured by digitizing temperature sensor 109 and digitizing relative humidity sensor 108, respectively, passing through sample head 100.
4) “Program A” then calculates the temperature of the air in the storage area or bin being sampled from the following measured or known factors: i) The temperature difference between sampled air when flowing through sample head 100 and the already measured ambient temperature of air in the storage facility; ii) The length of sample collection main line 200 from sample head 100 to solenoid valve 206; iii) The diameter of sample collection main line 200; iv) The volumetric flow of the stream of air being drawn through sample collection main line 200; and, v) the “R” value of the PVC pipe (and insulation, if any) of sample collection main line 200. A number of formulae are well known in the art whereby one can calculate the temperature variation experienced when delivering air at one temperature through a duct at another temperature. One such example is provided by the American Society of Heating, Refrigeration, and Air Conditioning Engineers (ASHRAE). Am. Socy. Of Heating, Refrigeration, and Air Conditioning Engrs., Handbook of Fundamentals, 4.21 (2009). For example, if the temperature desired in the storage area or bin in where sample collection lateral line 202 terminates is 50.0° F.; the ambient temperature in the storage facility is 40.0° F.; the length of sample collection main line 200 from the solenoid valve 206 is 100 ft.; the volumetric flow through sample head 100 generated by air evacuating means 102 is a nominal 30 cfm; the exterior diameter of sample collection main line 200 is 7.5 in.; and, the R-value of sample collection main line 200 is 0.5, then the temperature of the air as measured by digitizing temperature sensor 109 in sample head 100 will be 42.4° F. when a temperature of 50.0° F. has been attained in the sample area or bin in which sample collection lateral line 202 terminates. If the temperature in the area or bin drifts too high, say to 55.0° F., then the temperature of the air as measured by digitizing temperature sensor 109 in sample head 100 will be 43.6° F. Similarly, if the temperature in the area or bin drifts too low, say to 45° F., then the temperature of the air as measured by digitizing temperature sensor 109 in sample head 100 will be 41.2° F. Assuming the same scenario, but substituting a foam-insulated PVC sample collection main line with an R-value of 4, then the temperature of the air as measured by digitizing temperature sensor 109 in sample head 100 will be 46.7° F. when a temperature of 50° F. has been attained in the sample area or bin being tested. If the temperature in the area or bin drifts too high, say to 55° F., then the temperature of the air as measured by digitizing temperature sensor 109 in sample head 100 will be 50.1° F. Similarly, if the temperature in the area or bin drifts too low, say to 45° F., then the temperature of the air as measured by digitizing temperature sensor 109 in sample head 100 will be 43.4° F. These examples illustrate the desirability of insulating sample collection main line 200 in these more complex embodiments.
5) After recording the calculated temperature, measured temperature, and measured relative humidity of air drawn from the selected sample area or bin, “Program A” updates the computer's display to show, for example, calculated temperature, relative humidity, and a graphical view of the same data for some period of recent time. This is exemplified on FIG. 5 as “Program A Display.”
6) “Program B” then records the concentration of carbon dioxide gas present in the air drawn from the area or bin being sampled.
7) After recording the concentration of carbon dioxide in the selected area or bin, “Program B” updates the computer's display to show for example, the current and average carbon dioxide levels and a graphical view of the same data for some period of recent time. This is exemplified on FIG. 5 as “Program B Display.”
8) “Program C” then deactivates solenoid valve 206 closing sample collection lateral line 202 extending into the selected area or bin.
9) Computer 500 then repeats steps 1) through 7) appropriately substituting solenoid valves 207 and 208 and sample collection lateral lines 203 and 204 extending into the second and third storage areas or bins to be sampled, respectively.

“Program A”, “Program B”, and “Program C” communicate with each other to the extent that “Program A” and “Program B” are able to determine from “Program C” which of solenoid valves 205, 206, 207, or 208 is selected and thus whether sample collection main line 200 or one of sample collection lateral lines 202, 203, or 204, respectively, is open and being sampled. The identity of the selected solenoid valve, and thus the length of sample collection main line 200 from the selected sample line, is used by “Program A” to accurately calculate the temperature of the air in the area or bin being sampled and by both “Program A” and “Program B” to identify recorded data for later retrieval and display.

It will be obvious to one having skill in the art that “Program A”, “Program B”, and “Program C” need not be segregated into separate programs (as described) but may instead exist as software modules or objects combined into one software program. Moreover, although only a few exemplary embodiments of the present invention have been described in detail, those skilled in the art will readily appreciate that numerous minor modifications and rearrangements of the exemplary embodiments are readily conceivable. Accordingly, all such modifications and rearrangements are intended to be included within the scope of this invention as defined in the following claims.

What is claimed is:

1. A pumped air relative humidity and temperature sensing system with optional gas assay functionality, comprising:
a. a sample collection system comprising a single length of tubular sample collection main line with a gas permeable, dirt impervious filter at one end;
b. a sample head with enclosing walls and an open lumen, further comprising;
i. a sample collection main line adapter attached to one end of said sample head wherein said sample collection main line adapter further comprises a coupling suitable for attachment with the end of said sample collection main line opposite the end with said gas permeable, dirt impervious filter;
ii. an air evacuating means at the opposite end of said sample head capable of withdrawing air from said open lumen of said sample head, thence from: said sample collection line adapter; said sample collection line; and the area beyond said gas permeable, dirt impervious filter;
iii. a relative humidity sensor extending through the wall of said sample head and into said open lumen of said sample head capable of sampling the relative humidity of air passing through the open lumen of said sample head;
iv. a temperature sensor extending through the wall of said sample head and into said open lumen of said sample head capable of sampling the temperature of the air passing through said open lumen of said sample head; and
v. a sample tube for the attachment of a gas assay apparatus providing an open passageway from the outside of said sample head to said open lumen of said sample head such that said gas assay apparatus may sample the air passing through said sample head.

2. A pumped air relative humidity and temperature sensing system with optional gas assay functionality of claim 1, wherein said relative humidity sensor and said temperature sensor are direct read devices, each with a digital display capable of displaying measured relative humidity and temperature, respectively, in a human perceptible form.

3. A pumped air relative humidity and temperature sensing system with optional gas assay functionality of claim 2, wherein a direct read gas assay device is attached to said sample tube, said direct read gas assay device capable of determining and displaying data in a human perceptible form indicating the presence and concentration of a chemical substance in the air passing through said open lumen of said sample head wherein said chemical substance is a selection from the group consisting of:
a. carbon dioxide;
b. oxygen;
c. nitrogen;
d. ethylene;
e. hydrogen peroxide; and
f. isopropyl N-(3-chlorophenyl) carbamate.

4. A pumped air relative humidity and temperature sensing system with optional gas assay functionality of claim 1, wherein said relative humidity sensor and said temperature sensor emit an electrical signal coded to represent measured relative humidity and temperature, respectively.

5. A pumped air relative humidity and temperature sensing system with optional gas assay functionality of claim 4, wherein said relative humidity sensor and said temperature sensor are connected to a digital display device such that the electrical signals coded to represent measured relative humidity and temperature are displayed in a human perceptible form.

6. A pumped air relative humidity and temperature sensing system with optional gas assay functionality of claim 4, wherein said relative humidity sensor and said temperature sensor are connected to a general purpose computer executing a software program such that said electrical signals coded to represent measured relative humidity and temperature are digitized, stored, retrieved, and displayed in a human perceptible form.

7. A pumped air relative humidity and temperature sensing system with optional gas assay functionality of claim 6:
a. wherein a general purpose gas assay device is attached to said sample tube such that said general purpose gas assay device draws samples from said sample tube;
b. wherein said general purpose gas assay device is connected to said general purpose computer;
c. wherein said general purpose gas assay device emits an electrical signal coded to represent the identity of chemical compounds and the concentration of said chemical compounds present in the air drawn from said sample port; and
d. wherein said software program digitizes, stores, retrieves, and displays said electrical signals coded to represent the identity of chemical compounds and the concentration of said chemical compounds present in the air drawn from said sample port in a human perceptible form.

8. A pumped air relative humidity and temperature sensing system with optional gas assay functionality, comprising:
a. a sample collection system comprising a single length of tubular sample collection main line with a gas permeable, dirt impervious filter at one end;
b. a sample head with enclosing walls and an open lumen, further comprising;
i. a sample collection main line adapter attached to one end of said sample head wherein said sample collection main line adapter further comprises a coupling suitable for attachment with the end of said sample collection main line opposite the end with said gas permeable, dirt impervious filter;
ii. an air evacuating means at the opposite end of said sample head capable of withdrawing air from said open lumen of said sample head, thence from: said sample collection line adapter; said sample collection line; and the area beyond said gas permeable, dirt impervious filter;
iii. a relative humidity sensor extending through the wall of said sample head and into said open lumen of said sample head capable of sampling the relative humidity of air passing through the open lumen of said sample head;
iv. a temperature sensor extending through the wall of said sample head and into said open lumen of said sample head capable of sampling the temperature of the air passing through said open lumen of said sample head;
v. a gas assay device extending through the wall of said sample head and into said open lumen of said sample head capable of determining the presence and concentration of a chemical substance in the air passing through said open lumen of said sample head wherein said chemical substance is a selection from the group consisting of:
(1) carbon dioxide;
(2) oxygen;
(3) nitrogen;
(4) ethylene;
(5) hydrogen peroxide; and
(6) isopropyl N-(3-chlorophenyl) carbamate.

9. A pumped air relative humidity and temperature sensing system with optional gas assay functionality of claim 8, wherein said relative humidity sensor, said temperature sensor and said gas assay device are direct readout devices, each with a digital display capable of displaying measured relative humidity, temperature, and chemical substance concentration respectively, in a human perceptible form.

10. A pumped air relative humidity and temperature sensing system with optional gas assay functionality of claim 8, wherein said relative humidity sensor, said temperature sensor and said gas assay device emit an electrical signal coded to represent measured relative humidity, temperature, and chemical substance concentration, respectively.

11. A pumped air relative humidity and temperature sensing system with optional gas assay functionality of claim 10, wherein said relative humidity sensor, said temperature sensor, and said gas assay device are connected to a digital display device such that the electrical signals coded to represent measured relative humidity, temperature, and chemical substance concentration are displayed in a human perceptible form.

12. A pumped air relative humidity and temperature sensing system with optional gas assay functionality of claim 10, wherein said relative humidity sensor, said temperature sensor, and said gas assay device are connected to a general purpose computer executing a software program such that said electrical signals coded to represent measured relative humidity, temperature, and chemical substance concentration are digitized, stored, retrieved, and displayed in a human perceptible form.

13. A pumped air relative humidity and temperature sensing system with optional gas assay functionality, comprising:
a. a sample collection system comprising at least two sub-lengths of sample collection main line, each of which is connected linearly in succession to the preceding one by means of a “T” coupling to form a continuous sample collection main line;
i. wherein an terminating solenoid valve is connected to one end of said continuous sample collection main line;
(1) wherein a further sub-length of sample collection main line is connected to the open coupling of said terminating solenoid valve;
(2) wherein a gas permeable, dirt impervious filter covers the terminal end of said further sub-length of sample collection main line;
ii. wherein a sub-length of sample collection lateral line is connected to the open coupling of each of said “T” couplings;
iii. wherein a lateral solenoid valve is connected to the terminal end of each of said sub-lengths of sample collection lateral lines;
(1) wherein a further sub-length of sample collection lateral line is connected to the open coupling of each of said terminating solenoid valves;
(2) wherein a gas permeable, dirt impervious filter covers the terminal end of each of said further sub-lengths of sample collection lateral line;
iv. wherein said terminating solenoid valve and each of said lateral solenoid valves are connected to a valve selecting means capable of remotely opening and closing said terminating solenoid valve and each of said lateral solenoid valves;
b. a sample head with enclosing walls and an open lumen, further comprising;
i. a sample collection main line adapter attached to one end of said sample head wherein said sample collection main line adapter further comprises a coupling suitable for attachment with the end of said sample collection main line opposite the end with said gas permeable, dirt impervious filter;
ii. an air evacuating means at the opposite end of said sample head capable of withdrawing air from said open lumen of said sample head, thence from: said sample collection line adapter; said sample collection line; and the area beyond said gas permeable, dirt impervious filter;
iii. a relative humidity sensor extending through the wall of said sample head and into said open lumen of said sample head capable of sampling the relative humidity of air passing through the open lumen of said sample head;
iv. a temperature sensor extending through the wall of said sample head and into said open lumen of said sample head capable of sampling the temperature of the air passing through said open lumen of said sample head;
v. at least one gas assay device extending through the wall of said sample head and into said open lumen of said sample head capable of determining the presence and concentration of a chemical substance in the air passing through said open lumen of said sample head wherein said chemical substance is a selection from the group consisting of:
(1) carbon dioxide;
(2) oxygen;
(3) nitrogen;
(4) ethylene;
(5) hydrogen peroxide; and
(6) isopropyl N-(3-chlorophenyl) carbamate.

14. A pumped air relative humidity and temperature sensing system with optional gas assay functionality of claim 13, wherein said relative humidity sensor, said temperature sensor and said gas assay device emit an electrical signal coded to represent measured relative humidity, temperature, and chemical substance concentration, respectively.

15. A pumped air relative humidity and temperature sensing system with optional gas assay functionality of claim 14, wherein said relative humidity sensor, said temperature sensor, and said gas assay device are connected to a general purpose computer executing a software program such that said electrical signals coded to represent measured relative humidity, temperature, and chemical substance concentration are digitized, stored, retrieved, and displayed in a human perceptible form.

16. A pumped air relative humidity and temperature sensing system with optional gas assay functionality of claim 15, wherein said software program sequentially actuates said electrically operated terminating through valve and each of said electrically operated lateral through valves.
